(19) United States
(12) Patent Application Publication
(10) Pub. No.: US 2011/0098957 A1
(43) Pub. Date: Apr. 28, 2011

(54) MEASUREMENT APPARATUS AND METHOD FOR RAPID VERIFICATION OF CRITICAL OPTICAL PARAMETERS OF A VIEWING DISPLAY DEVICE SCREEN AND VIEWING ENVIRONMENT

(76) Inventors: NASIR J ZAIDI, Valencia, CA (US); Kenneth A. Miller, Simi Valley, CA (US)

(21) Appl. No.: 12/914,764

(22) Filed: Oct. 28, 2010

Related U.S. Application Data
(60) Provisional application No. 61/280,045, filed on Oct. 28, 2009.

(51) Int. Cl. G01N 21/25; G06F 15/00; G01J 1/42

(52) U.S. Cl. 702/85; 702/183; 356/416; 356/218

(57) ABSTRACT

A hand held measurement apparatus and method for in situ optical analysis of a specific display screen or viewing box and associated ambient light environment is disclosed. The apparatus uses a plurality of input collector optics and a plurality of optical filter/photodetectors as a device to separate the light output of an individual monitor screen, display screen, or viewing box and associated ambient light environment into key optical component intensities, the analysis of which are used to optimize the probability for a correct diagnosis by a qualified viewer/analyst. The optical signals are converted into digital electrical signals, processed, and compared to previously stored information of the specific viewing display and the viewing display environment in order to determine if the combination of viewing device and viewing environment is either GO (acceptable, in compliance) or NO GO (not acceptable, non-compliant) according to industry standards or approved procedures.

### PRIORITY

The present invention claims priority under 35 USC section 119 and based upon a provisional application with a Ser. No. 61/280,045 which was filed on Oct. 28, 2009

### BACKGROUND OF THE INVENTION

1. Field of the Invention

Embodiments of the present invention generally relate to a measurement apparatus and method for rapid verification of critical optical parameters of a specific monitor screen, display screen or viewing box and the ambient lighting of the associated viewing environment.

The ability to make a correct early diagnosis, for example, of certain forms of cancer, may mean detection of very small, early-stage tumors. This makes subsequent successful remedial action much more likely, resulting in recovery and a potentially longer life for many victims. However, early diagnosis may depend upon a trained viewer's ability to identify subtle, even minute changes in shading in an x-ray image.

Traditionally, viewing boxes, which include diffused sources of white light, have been used to back light an image on black and white film that was acquired by passing x-ray radiation through a body to expose film. A trained viewer then analyzes the exposed x-ray films as a means of diagnosis of tumors, etc. This was in part possible because of the large dynamic range of x-ray film. Critical viewing was often performed in a controlled, darkened environment to maximize the image contrast thereby virtually eliminating reflections of overhead lights, etc. from degrading the viewed image.

More recently, x-ray images, displayed on high resolution, monochromatic cathode ray tube (CRT) screens and color computer monitor screens, are replacing lamp-based viewing boxes. These images are digital in nature, replacing the need for film and film archival, with digital archival and ease of electronic copy, transfer and storage. However, digital images lack the dynamic range of film, and often cannot be viewed in an environment with the lights totally off, for example, when portable x-ray machines are used. Also, since monitors are not as stable as lamp-based viewing boxes, due to degradation, etc., the quality of the displayed image may not be adequate to minimize misdiagnosis.

Display and monitor manufacturers have attempted to mitigate the viewing device degradation issue by several methods: For example, by including an internal means to sample the light signal generated, or by including a built-in external monitoring device that is tethered to the monitor to aid in monitor calibration. The former method does not actually measure the light output from the point of view of the viewer, and the latter method is only available on a few monitor systems, and not appropriate for general use. Neither method accounts for the reduction in viewing screen contrast due to the ambient light issue.

In addition, new more energy-efficient lighting technologies are emerging, for example Organic Light-Emitting Diodes (OLEDs) and High Brightness Light-Emitting Diodes (HB-LEDs), and are appropriate for displays, display backlighting and industrial lighting. These and other technologies rely on limiting the spectral emission to the visible spectrum, thereby reducing energy that is usually wasted as heat, for example, as in incandescent lamps. Also, the quality of the emitted light is often preferred to light emitted, for example, from fluorescent lamps. However, these low-energy technologies rely on narrowband spectral emission which further complicates the interaction of the light emitted from the display screen, the ambient lighting, and ability of a qualified viewer/analyst to make a correct diagnosis. Initially these new lamps will be more expensive than the lamps they replace, but lighting quality and full lifetime costs should prevail in industrial applications, especially those which are as critical as medical diagnosis.

Standards have been written to quantify the minimum acceptable monitor optical parameters, such as light output intensity, monitor white point color, etc., and the ambient lighting requirements of the viewing surround.

2. Description of Related Art

These standards often require a calibration-traceable, precision optical instrument, such as a filter photometer, filter colorimeter, or spectrally-based variants, common in the art for the measurement of emissive sources such as computer monitor screens, and which also contain an optical input means for the measurement of reflective sources, such as the ambient light incident on computer monitor screens. Designed primarily for laboratory use by skilled users, these high quality variants are sufficiently accurate for monitor verification and alignment. However, they are both bulky and expensive, and thereby not suited for rapid and frequent use by operators in situ, nor are they optimized for a specific monitor screen and viewing situation.

There are two general classes of optical instrument means used to measure the intensity and color of emissive sources such as monitors, displays, and viewing boxes: Those based on the photoelectric tristimulus method and those based on the photoelectric spectral analysis method.

The photoelectric spectral analysis-based instruments for this application are generally called spectroradiometers or spectrocolorimeters. This method relies on an optical input means to acquire the optical signal, and uses either a dispersive element, and/or multiple or variable narrowband filters to divide the spectrum of the light signal emitted by the display monitor screen into narrow component bands of color. The light intensity levels of the spectral component colors are then converted to electronic signals by the photoelectric detecting device or devices, digitized, and processed by the computer/controller. Outputs are usually general purpose radiometric, photometric and colorimetric parameters, and are not optimized for a specific monitor screen and viewing situation or viewers.

The strength of this technique is high accuracy, especially for structured light sources such color monitor screens and new narrow band, energy efficient ambient sources of light. The major deficits, besides the aforementioned bulkiness and expense of these devices, is their reduced sensitivity due to the low signal levels in the narrow spectral component bands, and their lack of ruggedness, requiring constant recalibration.

Broadband optical filter/photodetector-based instruments are generally called photoelectric tristimulus colorimeters, because they divide the spectrum of the emitted light signal into much wider bands of color thereby mitigating the sensitivity issue, and are often filtered to approximate CIE tristimulus color-matching functions.

A photoelectric tristimulus colorimeter is used to measure the color of the light emitted from a light source, such as a computer display screen. An emissive photoelectric colorimeter directs the light through input optics to three or four photodetectors. A primary filter (green, red or blue) is positioned in front of each photoelectric detecting device. Each primary filter conforms, as closely as possible, the spectral sensitivity of the photoelectric detecting device to a linear combination of the color-matching functions. A measuring device, which is connected to the photoelectric detecting devices, reads or measures the intensity of the respective primaries or tristimulus values in response to the incident light. Although it is theoretically possible to design primary filters exactly corresponding to an ideal, it is practically impossible to manufacture primary filters having transmission factors exactly corresponding to the ideal. This is because an error is inherent in measuring primary or tristimulus values of the color sample. This is a spectral mismatch error and is caused by differences between actual and theoretical transmission factors of the primary filters.

Many past attempts have been made to overcome the inherent tristimulus spectral mismatch error with varying degrees of success, associated cost and complexity.

### U.S. Patent Documents

U.S. Pat. No. 6,819,306 November 2004 Cooper

### CROSS-REFERENCE TO RELATED APPLICATIONS

The present application contains subject matter related to U.S. Pat. No. 6,819,306 by Ted J. Cooper entitled “Color correcting and ambient light responsive CRT system” which is incorporated by reference in its entirety. Mr. Cooper describes a display system including an optical sensor system as a light emitting color display system having an optical sensor system comprising: a plurality of photosensors directed towards and away from said light emitting color display system for respectively providing a plurality of display and ambient color outputs proportional to the light energy applied thereto respectively from and away from said light emitting color display system, each of said plurality of photosensors associated with a color of light respectively from and away from said light emitting color display system; a control system for controlling each color of light from said light emitting color display system; and a processing system connected to said plurality of photosensors and said control system, said processing system responsive to said plurality of display and ambient color outputs to compare said plurality of display and ambient color outputs over time with an initial plurality of display and ambient color outputs and including a mechanism for providing information to allow compensation for color differences respectively from and away from said light emitting color display system over time.

None of the present art solutions address the ability to rapidly affirm that a specific viewing display device screen and viewing environment is acceptable or not acceptable by means of a GO or NO GO indication.

### DESCRIPTION OF THE INVENTION

The present invention includes various embodiments for a hand held measurement apparatus and method for in situ optical analysis of a specific display screen or viewing box and associated ambient light environment.

1. One embodiment is the design of a portable, hand held solid-state optical light intensity and color-measuring apparatus that can be optimized for a specific monitor viewing screen and associated viewing environment for the rapid verification of monitor viewing environment performance per industry standards. The solid-state optical light intensity and color-measuring device includes both a plurality of input optics and a plurality of broadband and/or narrow bandpass optical colorant filters and light detector channels that are selected to optimize the performance of a specific monitor viewing screen and viewing environment. The colorants comprise optical filters and light passes through the filters to cause the light detectors to produce an output electrical signal proportional to the input light signal. The output of all the detectors can be combined by the included processor to approximate the spectral responses of one or more CIE-like color-matching functions, and/or used to more accurately assess the narrow-band nature of the incoming structured light signal. The internal microcontroller software module determines the resulting GO/NO GO status by being in a first predetermined state or a second predetermined state and displays the result and predicts when probable non-compliance may occur.
2. A second embodiment is the design of a closed-loop automated or semi-automated test method for said viewing screen verification and/or monitor self-calibration/alignment including the said optical measurement apparatus from the first embodiment with an external computer and application-specific software test modules. The said optical measurement apparatus is either affixed adjacent to the screen or mounted on a positioning device adjacent to the screen and placed at a specific location. An external computer is commanded to display a certain test pattern or light intensity level and the said optical measurement apparatus evaluates and/or records the measured results. The cycle is repeated until the test is completed.
3. A third embodiment is the design of added capability to the said optical measurement apparatus from the first embodiment, with a device to update, customize outputs or add optional software application modules remotely, e.g., via the internet, to insure ongoing compliance to future standards, etc., after initial purchase.

### BRIEF DESCRIPTION OF THE DRAWINGS

The foregoing objects, features and advantages of the invention will become more apparent from a reading of the following description in connection with the accompanying drawings, in which:

FIG. 1 is a block diagram illustrating a measuring device;

FIG. 2 is a perspective view of a Measuring Apparatus Housing with a partially cut away sectional view of light Collector A and a plurality Optical Filters and Photodetectors;

FIG. 3 is a perspective view of a Measuring Apparatus with partially cut away sectional view of a light Collector B and a plurality Optical Filters and Photodetectors;

FIG. 4 is a detailed block diagram of a Measuring Apparatus;

FIG. 5 is a block diagram of a measuring apparatus and a remote computer;

FIG. 6 is a detailed block diagram of circuitry of a measuring apparatus.

### DETAILED DESCRIPTION

Reference now should be made to the drawings.

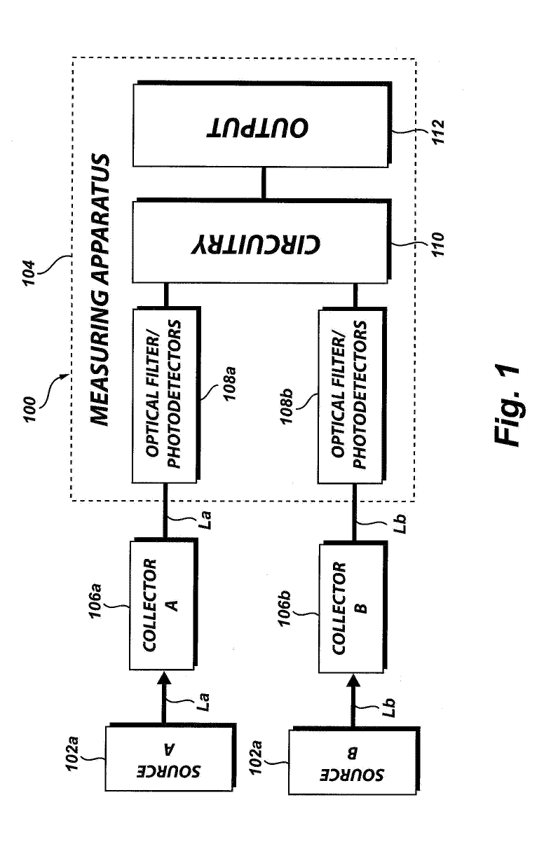

Referring more particularly to the drawings, a device 100 for measuring light L from a source 102a is illustrated in FIG. 1. As described in detail below, the measuring device 100 may be utilized for measuring light from a variety of luminance sources, such as sources like CRT, LED, LCD, Viewing box displays. According to a number of embodiments, the measuring device 100 is configured to measure light from a source in situ, that is, at the installation site of the source. One embodiment in which this feature is useful is where the measuring device 100 is configured to test the brightness of displays. Other embodiments will also be discussed below.

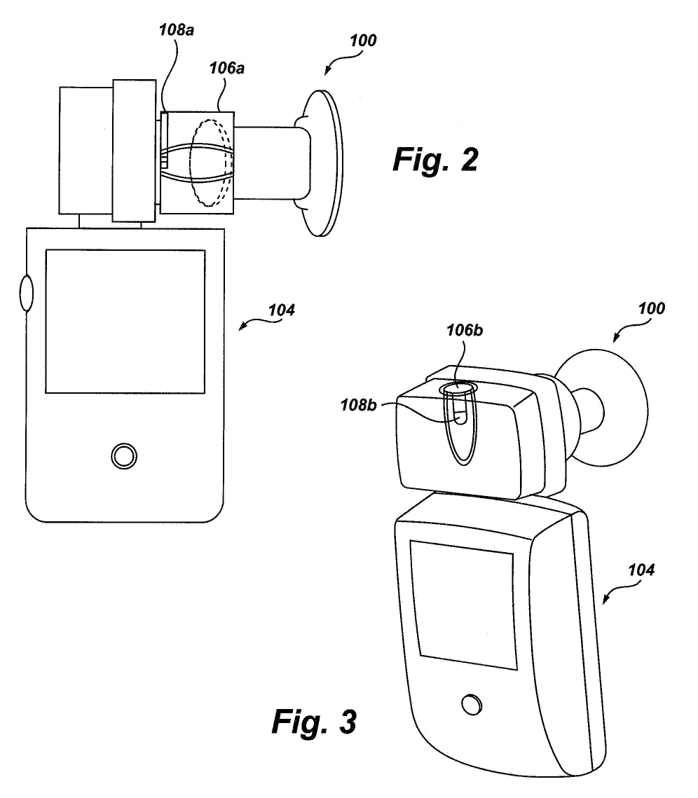

According to a number of embodiments, the device 100 includes a measuring apparatus 104 and a luminance collector 106a. The measuring apparatus 104 may include a detector 108a, circuitry 110 for processing output signals from the detector 108a, and an output 112 such as a display. With additional reference to FIG. 2, the collector 106a engages with the measuring apparatus 104 such that light L from the source 102a is incident on the detector 108a, which incident light is indicated by L. In many embodiments, the collector 106a is configured to be releasable engageable with the measuring apparatus 104, which will be discussed in more detail below.

According to a number of embodiments, the device 100 includes a measuring apparatus 104 and an ambient integrator 106b. The photometer 104 may include a detector 108b, circuitry 110 for processing output signals from the detector 108b, and an output 112 such as a display. With additional reference to FIG. 2, the collector 106b engages with the measuring apparatus 104 such that light L from the source 102b is incident on the detector 108b, which ambient light is indicated by L′. In many embodiments, the collector 106b is configured to be releasable engageable with the measuring apparatus 104, which will be discussed in more detail below.

Referencing FIG. 2, the measuring device 100 may be configured to measure light from a plurality of light sources 102a, 102b, . . . 102N. As shown, each source 102 may have a predetermined configuration or a predetermined size that is different from the other sources. In these embodiments, the measuring device 100 may include a plurality of collectors 106a, 106b, . . . 106N each having a light collector that is configured to complement the configuration of a respective one of the sources 102. In addition, each collector 106 may include engagement structure 126 that is configured to releasably engage with complementary engagement structure 128 disposed on the photometer 104. Accordingly, in a number of embodiments, light from a plurality of sources 102 may be measured with a single measuring apparatus 104 and a plurality of interchangeable collectors 106.

Referencing FIG. 2, in a number of embodiments the photometer 104 may be a portable hand-held device including a body 134 and a head 136, with the head being configured to receive the collector 106. The body 134 may house the circuitry 110 and the output 112 (see FIG. 1), and the head 136 may house the detector 108. The head and body 134 and 136 may be connected by a swivel connector 137.

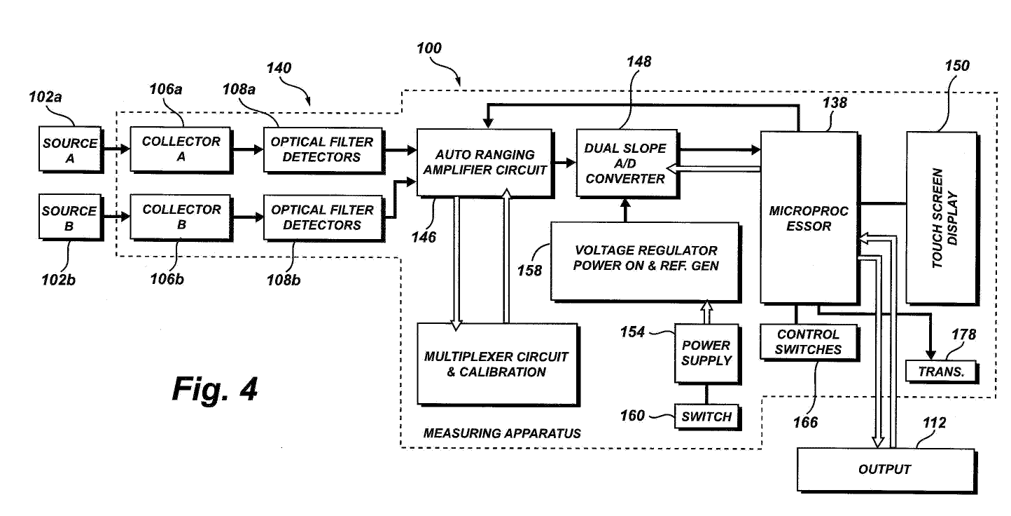

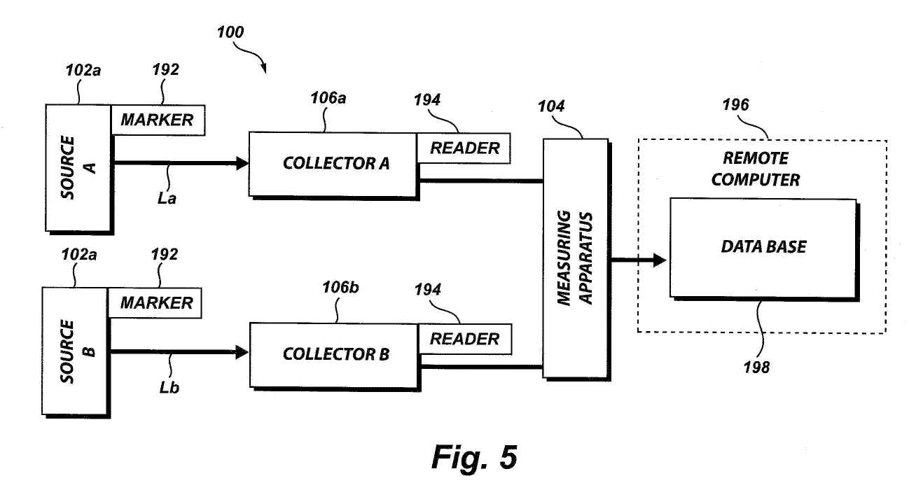

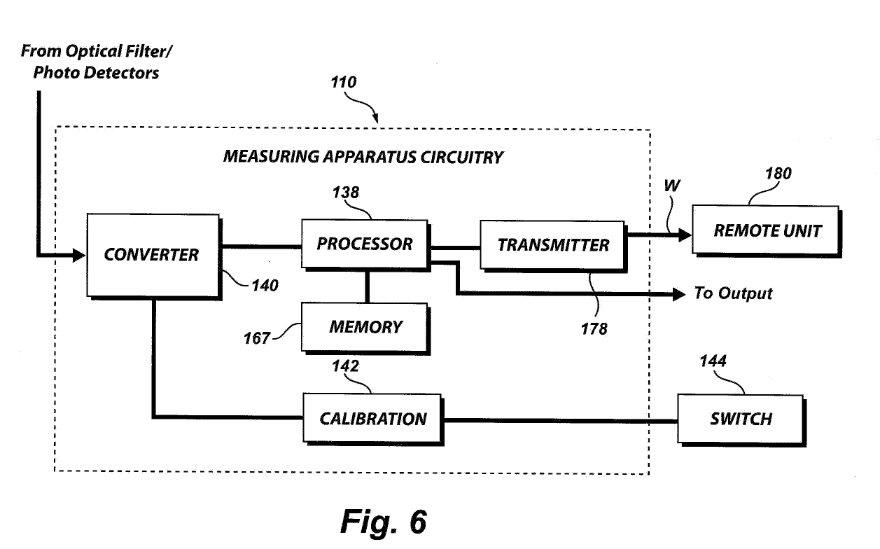

Referring to FIG. 4, a light collector is selected from a plurality of input optical light collectors 106a, 106b and depends upon the optical parameter being measured. For example measurement of viewing display screen parameters from Source A 102a requires imaging input optics light Collector A 106a per FIG. 2, while the measurement of ambient lighting Source B 102b requires a diffuse input optical light Collector B 106b per FIG. 3. Referring to FIG. 2 or 3, Housing 104 of the hand held Measuring Apparatus 100 is positioned adjacent to the viewing display screen Source A.

Again referring to FIG. 4, the collected light signal La or Lb passes through one or more of the plurality of Optical Filter/Photodetector 108a 108b channels simultaneously and is converted into parallel electrical signals, amplified by Autoranging Amplifier Circuit 146, digitized by the Dual Slope A/D Converter 148, processed and evaluated, by the integral Microprocessor 138 which may be connected to control switches 166 and stored in the internal memory per an application-specific software program module. The A/D converter 148 may be connected to a voltage regulator 158 for voltage regulation which may be connected to a power supply 154 which may be connected to a switch 160 to control the power. For rapid verification, said apparatus also includes software that contains the key optical viewing parameters and limits of acceptability and calibration data. The resultant plurality of Outputs 112 include measurement GO/NO GO status to indicate a first predetermined state (GO) or the second predetermined state (NO GO), the results of which is displayed on a Touchscreen Display 150 readout, and archival for future comparisons and/or ongoing monitoring to predict a potential out-of-tolerance status before occurrence also displayed on Touchscreen Display 150. Output 112 data may also be sent to the host computer by hardwired or wireless interface Transmitter/Receiver 178 for further archival, transfer, automatic test, etc.

The exact apparatus Optical Filter/Photodetector 108 elements are selected at the time of purchase from a list of candidates by the manufacturer to be the most optimal given the specific classes of monitor or viewing screen technology lighting signal La from Source A 102a and viewing environment lighting signal Lb from Source B 102b (monochrome or color CRTs, LCDs, LEDs, OLEDs, HB-LEDs, etc.) to be measured. The selection of optical filter elements is dependent upon the nature of the light signals La emitted by the display viewing screen, the ambient surround light signal Lb, and applicable industry standards and approved procedures. Optional software modules are anticipated to further customize Outputs 180 so as to maintain compliance with future industry standards.

Light may be characterized by a number of parameters, including intensity and color. According to some of the embodiments, the detector 108a 108b may provide an output that is indicative of at least one parameter of the light L, e.g., intensity. Referencing FIGS. 1 and 4, the circuitry 110 may include a processor 138 for processing the output of the detector 108. Based on this processing, the display 112 may provide an indication of the parameter of the light L responsive to the output of the detector. For example, the display 112 may output a numeric indication of the value of the intensity. Alternatively, the display 112 may output an indication on whether the intensity meets a predetermined threshold. In addition to a visual display such as an LCD, the output 112 may provide an audio output.

The measuring apparatus circuitry 110 may also include a converter 140. In some of the embodiments, the detector output may be an analog signal, with the converter 140 digitizing the signal for the processor 138.

A number of embodiments of the measuring device 100 may include circuitry 110 as shown in FIG. 4. For example, the converter 140 may include an amplifier 146 connected to the detector 108 for amplifying the output signal therefrom. The converter 140 may include an analog-to-digital (A/D) converter 148 for converting the amplified signal to a digital signal for the processor 138. As mentioned, the output 112 may include a display, such as a liquid crystal display (LCD) 150 with a driver circuit 152 for receiving output signals from the processor 138.

A power supply 154 may include a battery 156 connected to a voltage regulator 158 for supplying power to the other components of the circuitry 110. An ON/OFF switch 160 may be provided for actuating the measurement of the light L.

Any number of control switches 166 may also be provided for actuating additional functions. For example, based on the signal from the detector 108, the processor 138 may be configured to estimate when the intensity of the light L from the source 102 falls below a threshold. As mentioned, the intensity and the critical parameters of the display over time. Accordingly, based on known degradation characteristics, for example, stored in a memory 167 (see FIG. 4, the processor 138 may compare the measured value of critical parameters of the display with the known characteristics to estimate when the intensity will fall below a certain level or threshold. The display 112 may then provide an indication of the same.

According to a number of embodiments, the measuring device 100 may be configured to transmit data wireless to a remote location. More specifically, with further reference to FIG. 4, the measuring apparatus circuitry 110 may include a transmitter 178 in communication with the processor 138.

Accordingly, responsive to the signal received from the detector 108, the transmitter 178 may wirelessly transmit a signal to a remote unit 180, which signal is indicated by W. In some of the embodiments, the calibration circuit 142 may receive calibration signals from the remote unit 180 for calibrating the converter 140 depending upon the parameters of the source 103.

The remote unit 180 may include an electronic information device capable of receiving data wirelessly such as a personal digital assistant (PDA), a palm-top or lap-top computer, a cellular device, or a desk-top computer with a wireless modem. Although the drawings indicate one-way data transmission, the circuitry 110 may be configured to receive data wireless as well; i.e., in certain embodiments, the transmitter 178 may be configured as a transceiver 178.

In addition to determining the type of source based on parameters as discussed above, in other embodiments the measuring apparatus 100 may be configured to determine a particular individual source installed at a specific location. More particularly, with reference to FIG. 1, each source 102 to be measured may include an identifying marker 192 that includes information specific thereto, e.g., a barcode. Complementarily, the measuring device 100 may include a reader 194 for reading the data of the marker 192. The reader 194 may be disposed on the collector 194 as shown.

When the measurement of the light L is completed, data associated with the measurement and the source 102 may be sent to a remote computer 196 with a database 198. Based on the received data, the computer 196 may look up in the data base specific information on the source 102, for example, manufacturer name, warranty information, operating parameters, and so on.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

We claim:

1. A hand held measurement apparatus for rapid verification of critical optical parameters of a viewing device screen and viewing environment in situ comprising:
a housing;
a plurality of light collector optics;
a plurality of optical colored filter and photodetector channels for generating data, in parallel, in response to sensed light; and
a plurality of optical filters each being paired with one of the plurality of photodetectors, each of the optical filter/photodetector pairs having a responsivity which is optimized for measurement of light output from a specific viewing device screen and viewing environment ambient lighting, or class of viewing device screens or viewing environment lighting; an integral microcontroller and associated software for the processing, storage, analysis, readout and transfer of the measured values;
said integral microcontroller and associated processing, storage and analysis software also having the ability to rapidly determine GO/NO GO status compared to approved procedures and/or industry standards and display the results on the integral readout;
said apparatus also includes the ability to archive the measurement results and compare data sets over time and to use that information to predict and thereby prevent future noncompliance; said apparatus has the ability to be interfaced with a host computer for remote archival, fully-automated or semi-automated tests; and said apparatus has the further ability of the internal software to be updated remotely or optional application modules to be added to maintain compliance over time when approved procedures and/or industry standards are changed.

2. The measuring apparatus as set forth in claim 1, wherein the said plurality of optical filters each being paired with one of the said plurality of photodetectors is for parallel detection of the optical signal in discreet pass bands.

3. The measuring apparatus as set forth in claim 1, wherein each of the said optical filter/photodetector pairs have a responsivity which is near optimized for measurement of light output from a specific viewing device screen and viewing environment lighting, or class of viewing device screens or viewing environment lighting.

4. The measuring apparatus as set forth in claim 1, wherein the said apparatus includes an integral microcontroller and associated software for the processing, storage, analysis, readout and transfer of the measured values.

5. The measuring apparatus as set forth in claim 1, wherein the said apparatus and the said integral microcontroller and associated processing, storage and analysis software have the further predictive ability to rapidly determine GO/NO GO status compared to approved procedures and/or industry standards and display the results on the integral readout.

6. The measuring apparatus as set forth in claim 1, wherein said apparatus has the ability to be interfaced with a host computer for remote archival, fully-automated or semi-automated tests.

7. The measuring apparatus as set forth in claim 1, wherein said apparatus has the further ability of the internal software to be updated remotely and/or optional application modules to be added to maintain compliance over time when approved procedures and/or industry standards are changed.

8. A measuring apparatus for measuring critical optical parameters of a specific display screen and ambient environment, the measuring apparatus comprising:
a housing configured to receive light from the display screen in parallel through an attached plurality of input light collector optics; and
a plurality of optical filter/photodetectors attached to the housing and having an output light signal which is representative of the intensity and color of light from the display screen or ambient light source.

9. The measuring apparatus a recited in claim 1, further comprising a circuit configured to produce a selected one of the plurality of calibrated light signals, each calibrated signal corresponding to light from a display screen or ambient light having a predetermined color, intensity and shape.

10. The measuring apparatus as recited in claim 1, further comprising a circuit configured to produce a selected one of the plurality of calibration signals, each calibrated signal corresponding to light from a display screen or ambient light having a predetermined intensity.

11. The measuring apparatus a recited in claim 1, further comprising a circuit configured to produce a selected one of the plurality of calibration signals, each calibrated signal corresponding to light from a display screen or ambient light having a predetermined color.

12. The measuring apparatus as recited in claim 1, further comprising a predictor of determining when display screen output will degrade below predetermined level.

13. The measuring apparatus as recited in claim 1, further comprising a predictor circuit for determining when display screen output will degrade below predetermined level.

14. The measuring apparatus as recited in claim 1, further comprising a predictor firmware for determining when display screen output will degrade below predetermined level.

15. The measuring apparatus as recited in claim 1, further comprising a data collector and predictor for recording and displaying data representative of the display screen brightness level over time and for determining when display screen output will degrade below a predetermined level.

16. A method for measuring an intensity of light from a viewing display screen and ambient lighting environment, method comprising the steps of:
receiving the intensities of light from a viewing display screen and ambient light via a plurality of optical collectors; and
detecting the received light intensities via a plurality of optical filter and photodetectors having an output which is representative of the intensity of light from the viewing display screen or ambient light.

17. A method for measuring an intensity of the colors of light from a viewing display screen and ambient lighting environment, method comprising the steps of:
receiving the colored light from a viewing display screen or ambient light; and
detecting the received intensities of the color components of the light via a photodetector having an output which is representative of the intensity of the colored light from the viewing display screen or ambient light.
